(19) United States
(12) Patent Application Publication
(10) Pub. No.: US 2022/0040750 A1
(43) Pub. Date: Feb. 10, 2022

(54) DIE ASSEMBLY AND METHOD OF USE FOR MANUFACTURING BACKING PLATES OF FRICTION ASSEMBLIES

(71) Applicant: Util Canada Limited, Concord (CA)

(72) Inventor: Raj THALAPPATH, Concord (CA)

(21) Appl. No.: 17/106,628

(22) Filed: Nov. 30, 2020

(30) Foreign Application Priority Data
Aug. 7, 2020 (CA) 3089410

(51) Int. Cl. B21D 37/10; B21D 28/26

(52) U.S. Cl. CPC B21D 37/10; B21D 28/26

(57) ABSTRACT

A die assembly for use in manufacturing backing plates for friction assemblies includes a die assembly plate having a number of holes or recesses into which individual cutting tools can be inserted. The die assembly can be used in a press to create a pattern of retention features on the backing plate for providing a mechanical interface for retaining a friction material. The holes or recesses that individual cutting tools are located in on the die assembly plate can be changed to create different patterns for different backing plates and/or different friction material.

### CROSS-REFERENCE TO RELATED APPLICATION

The current application claims priority to previously filed Canadian Patent Application 3,089,410 filed Aug. 7, 2020 and titled “Die Assembly and Method of Use For Manufacturing Backing Plates of Friction Assemblies,” the entire contents of which are incorporated herein by reference in its entirety for all purposes.

### TECHNICAL FIELD

The current disclosure relates to backing plates used in friction assemblies used with brakes on vehicles, and more particularly to a die assembly useful in creating a pattern of retention features on the backing plates.

### BACKGROUND

FIGS. 1A and 1B depict an illustrative friction assembly. The friction assembly 100 may be used in a brake system such as the brakes of a vehicle and are typically a replaceable portion of the brake system. In disk brakes, for example, friction assembly, or brake pad, contacts a rotor to provide a stopping force. The friction assembly 100 generally comprises a backing plate 102 on which one or more sections of friction material 102a, 102b (referred to collectively as friction material 102) are mounted. The backing plate 104 may have various features for mounting the friction assembly within the brake system, while the friction material 102 provides a consumable material that contacts the rotor during operation of the brake system.

The friction material may be retained on the backing plate in various ways, including for example by an adhesive, or by a mechanical interface. A mechanical interface may provide an improved interface between the friction material and the backing plate compared to the use of adhesive. However a mechanical interface typically requires machining the mechanical interface onto the backing plate.

FIG. 2A depicts a backing plate 102 that has a mechanical interface machined thereon. The mechanical interface comprises a plurality of formed retention features, one of which is labelled as 204. Each retention feature may comprise a piece of the backing plate that has been raised from the backing plate as depicted in detail 206. The friction material may be pressed onto the backing plate over the retention features. The retention features press in to the friction material to retain the friction material on the backing plate.

FIG. 2B depicts a process for forming the retention features in a press. The retention features are formed in a pattern that corresponds to the shape of the friction material. A backing plate blank 202 may be retained within a press that has an upper assembly 208 and lower assembly 210. A blade stack 212 is retained within the upper assembly 208. The upper assembly is moved relative to the lower assembly as depicted by arrow 214, which causes the blade stack 212 to form the pattern of retention features on the backing plate blank.

FIG. 2C depicts a bottom view of the blade stack 212. The blade stack may be formed from a plurality of blades 212a. 212v that have been stacked together. Each blade comprises a plurality of cutting edges that each form a respective retention feature in the pattern of retention features.

The blade stack 212 cuts or otherwise forms all of the retention features in the desired pattern for a particular backing plate in a single press operation. However, different shapes of backing plates, and/or different shapes of friction materials require different blade stacks, which can increase the cost and complexity of maintaining the components necessary for manufacturing different backing plates or friction assemblies.

### SUMMARY

In accordance with the present disclosure there is provided a method of preparing a press to form a backing plate for a friction assembly, the method comprising: determining a plurality of individual cutting tool locations in a die assembly plate to provide a desired pattern of retention features on a backing plate for retaining a friction material the die assembly plate comprising a plurality of individual cutting tool retention features, each of the plurality of individual cutting tool retention features capable of retaining a respective individual cutting tool; for each individual cutting tool location of the determined plurality of individual cutting tool locations in the die assembly plate, retaining a respective individual cutting tool by a respective cutting tool retention feature of the die assembly plate at the individual cutting tool location; and fitting the die assembly plate to the press.

In a further embodiment of the method, each individual cutting tool comprises a pin having a single cutting edge.

In a further embodiment of the method, the pin of a respective individual cutting tool has a cross-sectional profile to align an orientation of the cutting edge relative to the die assembly plate when the respective individual cutting tool is retained by the cutting tool retention feature.

In a further embodiment of the method, the cross-sectional profile to the respective individual cutting tool is a D shape.

In a further embodiment of the method, each individual cutting tool retention feature comprises a hole or recess within the die assembly plate shaped to receive the respective individual cutting tool, and wherein retaining each individual cutting tool in the respective cutting tool comprises inserting the individual cutting tool in the hole or recess within the die assembly plate.

In a further embodiment of the method, fitting the die assembly plate to the press is done after retaining one or more of each individual cutting tool in the die assembly plate.

In a further embodiment of the method, fitting the die assembly plate to the press is done prior to retaining one or more of each individual cutting tool in the die assembly plate.

In accordance with the present the disclosure, there is further provided a method of forming backing plates for a friction assembly, the method comprising: preparing a press according to any of the embodiments of the method for preparing a press described above; and operating the press to form a plurality of backing plates having retention features formed in accordance with the desired retention feature pattern.

In a further embodiment, the method further comprises: determining that an individual cutting tool should be replaced; and replacing the determined individual cutting tool.

In accordance with the present the disclosure, there is further provided a method of preparing a die assembly for use in forming a pattern of retention features on a backing plate in a press, the method comprising: determining a plurality of individual cutting tool locations in a die assembly plate to provide a desired pattern of retention features on a backing plate, the die assembly plate comprising a plurality of individual cutting tool retention features, each of the plurality of individual cutting tool retention features capable of retaining a respective individual cutting tool; and for each individual cutting tool location of the determined plurality of individual cutting tool locations in the die assembly plate, retaining a respective individual cutting tool by a respective cutting tool retention feature of the die assembly plate at the individual cutting tool location.

In accordance with the present the disclosure, there is further provided a die assembly comprising: a die assembly plate having at least one mounting surface for use in retaining the die assembly plate within a press for manufacturing backing plates of friction assemblies, wherein the die assembly comprises a first plurality of retention features arranged over a face of the die assembly plate, each of the retention features shaped to retain an individual cutting tool; and a second plurality, less than the first plurality, of individual cutting tools retained by respective retention features of the die assembly plate.

In a further embodiment of the die assembly, each individual cutting tool comprises a pin having a single cutting edge.

In a further embodiment of the die assembly, the pin of a respective individual cutting tool has a cross-sectional profile to align an orientation of the cutting edge relative to the die assembly plate when the respective individual cutting tool is retained by the cutting tool retention feature.

In a further embodiment of the die assembly, the cross-sectional profile to the respective individual cutting tool is a D shape.

In a further embodiment of the die assembly, each individual cutting tool retention feature comprises a hole or recess within the die assembly plate shaped to receive the respective individual cutting tool, and wherein each individual cutting tool is retained in the respective cutting tool by a friction fit of the individual cutting tool in the hole or recess within the die assembly plate.

In accordance with the present the disclosure, there is further provided a die assembly kit comprising: a die assembly plate having at least one mounting surface for use in retaining the die assembly plate within a press for manufacturing backing plates of friction assemblies, wherein the die assembly comprises a first plurality of retention features arranged over a face of the die assembly plate, each of the retention features shaped to retain an individual cutting tool; and a second plurality of individual cutting tools shaped to be retained by respective retention features of the die assembly plate.

### BRIEF DESCRIPTION OF THE DRAWINGS

Further features and advantages of the present disclosure will become apparent from the following detailed description, taken in combination with the appended drawings, in which:

FIG. 1A depicts a top view of a friction assembly;

FIG. 1B depicts a cross section view taken along line B-B′ in FIG. 1A;

FIG. 2A depicts a backing plate of a friction assembly;

FIG. 2B depicts a prior art process of forming the backing plate of FIG. 2A;

FIG. 2C depicts a bottom view of a blade stack used in the process depicted in FIG. 2B;

FIG. 3A depicts a backing plate of a friction assembly;

FIG. 3B depicts a die assembly used in creating the backing plate of FIG. 3A;

FIG. 3C depicts a process of forming the backing plate of FIG. 3A using the die assembly of FIG. 3B;

FIG. 4 depicts a die assembly plate;

FIG. 5 depicts an individual cutting tool;

FIG. 6A depicts a side view of an individual cutting tool;

FIG. 6B depicts a front view of the individual cutting tool of FIG. 6A;

FIG. 6C depicts a bottom view of the individual cutting tool of FIG. 6A; and

FIG. 7 is a flow chart depicting an exemplary method of forming backing plates using a die assembly.

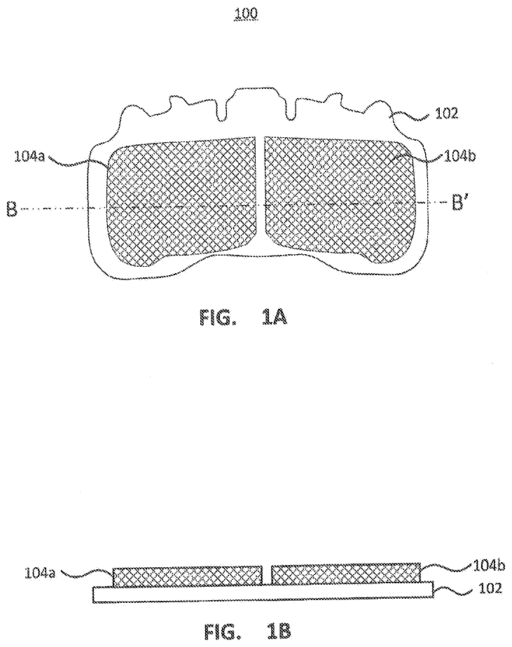

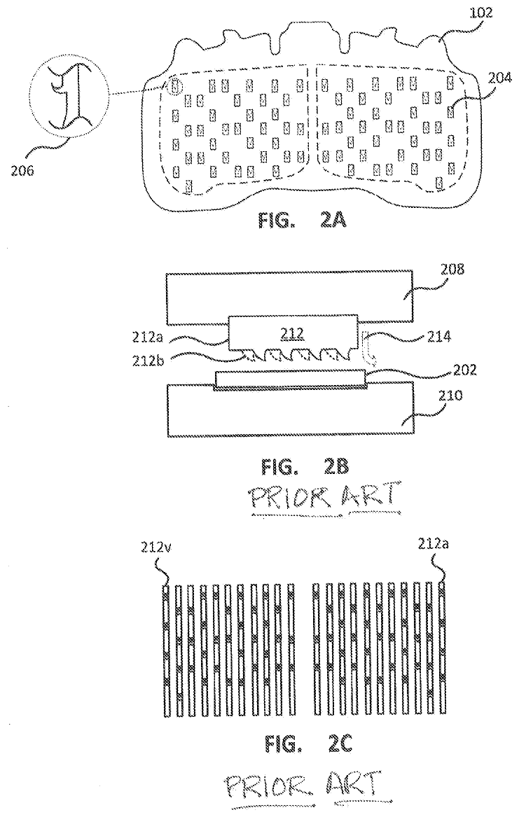

### DETAILED DESCRIPTION

The pattern of retention features on backing plates for friction assemblies has previously been formed using blade stacks of individual blades with multiple cutting edges on each blade. While the use of blade stacks produces a suitable pattern of retention features, different blade stacks need to be created for friction assemblies that have different shapes or sizes. Each blade stack may be expensive and as such may be unsuitable for low volume and/or low cost production of backing plates. Further, in a production environment, it can be desirable to have one or more backups of the blade stacks, which can add not only additional cost but also additional complexity in maintaining and storing different blade stacks for each different backing plate that may be manufactured. Further, if a single cutting edge of a blade is broken, the entire blade is replaced even if the other cutting edges on the blade are still in good condition.

As described further below, the pattern of retention features may be formed using a die assembly having individual cutting tools, instead of a blade stack. Advantageously, the die assembly may be retained in the press equipment previously used with blade stacks. The die assembly has a die assembly plate with a number of holes or recesses formed thereon. Individual cutting tools can be inserted into the appropriate holes or recesses of the die assembly plate in order to provide the desired pattern of retention features on the backing plate. Advantageously, the same die assembly plate and individual cutting tools can be used to create different patterns of retention features by changing the holes or recesses that cutting tools are located in. Further, if a cutting edge of an individual cutting tool is damaged, the individual cutting tool can be replaced without having to replace other undamaged cutting edges. Further still, since the same die assembly plate and individual cutting tools can be used to create different patterns of retention features for different backing plates, the number of spare components can be reduced.

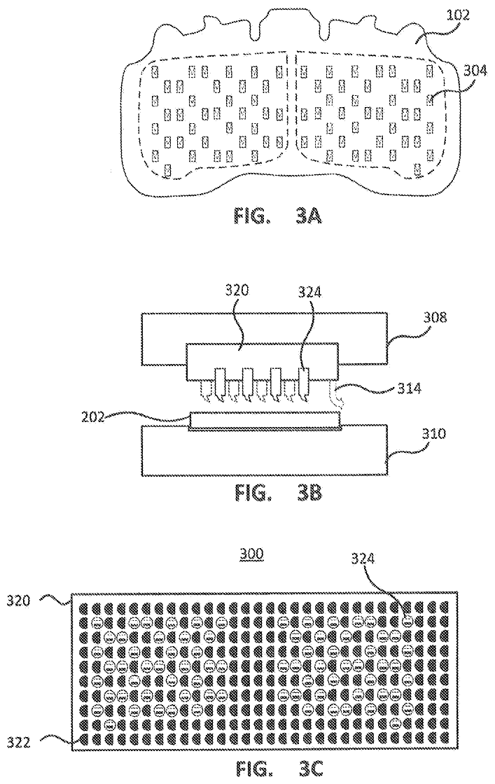

FIG. 3A depicts a backing plate of a friction assembly. The backing plate 102 has a number of retention features 304 formed in or on the backing plate 102 in a pattern. The pattern of the retention features 304 may correspond with the size, shape and placement of the friction material on the backing plate 102. The specific pattern of the retention features 304 may vary. The shape of the retention features 304 may also vary.

FIG. 3B depicts a process of forming the backing plate 102 of FIG. 3A using a die assembly. Once the die assembly is assembled to provide the desired pattern of retention features 304 it can be fitted to a press. Generally, a press will have an upper assembly 308 and lower assembly 310 although the terms are relative to each other and the actual arrangement does not need to be vertical, one above the other. A die assembly comprising plurality of individual cutting tools 324 secured to a die assembly plate 320 may be mounted to the upper assembly 308 of the press and a backing plate or backing plate blank 202, mounted to or placed on the lower assembly 310. The upper and lower assemblies 308, 310 are moved relative to each other as depicted by arrow 314 in order to bring the individual cutting tools 324 into contact with the backing plate or backing plate blank 202. The relative motion of the upper and lower assemblies 308, 310, or more particularly the relative motion of the die assembly with the individual cutting tools 324 and the backing plate or backing plate blank 202, forms the pattern of retention features 304 on the backing plate 102 (FIG. 3A). Once the pattern of retention features 304 is formed on the backing plate 102, the backing plate can be removed and a new backing plate blank 202 inserted on lower assembly 310. The finished backing plates 102 may then be mated with the friction material by pressing the friction material into the pattern of retention features 304 formed on the backing plates. The backing plates 102 may be further processed either before or after being mated with the friction material, for example to shape or form other features, or cut the backing plate to final dimensions. The pattern of retention features 304 provides a mechanical interface for mating the friction material with the backing plate 102. While the mechanical interface may be sufficient to retain the friction material on the backing plate 102 on its own, other techniques for retaining the friction material on the backing plate may be used in conjunction with the mechanical interface.

Although described as having a single forming step in which the upper and lower assemblies 308, 310 are moved relative to each other in a single direction, i.e. as depicted by arrow 314, forming the retention features 304 may be done in a plurality of steps. At each step, respective upper and lower plates 320, 202 are moved relative to each other in different directions. For example, a backing plate 202 may have a first set of retention features 304 formed by relative movement of the cutting tools 324 from the left to the right, as shown in FIG. 3B. The backing plate 202 may be moved to a second forming step in which cutting tools 324 are moved from the right to the left to form a second set of retention features 304. The pattern and position of the cutting tools 324 at each step may be offset from each other such that the retention features 304 are not formed on or overtop of other retention features.

FIG. 3C depicts a die assembly 300 used in the process of FIG. 3B. As described above, a die assembly 300 holding a plurality of individual cutting tools 324 may be used to produce a desired pattern of retention features 304 on a backing plate 202. The die assembly 300 comprises a die assembly plate 320 that has a plurality of cutting tool retaining features, one of which is labelled 322, formed thereon. The cutting tool retaining features 322 may be any feature or structure that allows individual cutting tools to be secured to the die assembly plate 320 at particular locations. A number of individual cutting tools 324 can be secured to respective cutting tool retaining features in order to provide a die assembly 300 that will form the desired pattern of retention features 304 in a backing plate.

Advantageously, a different pattern of retention features may be provided using the same die assembly plate 320 and individual cutting tools 324 by repositioning the individual cutting tools, along with possibly adding or removing additional or excess individual cutting tools, to different cutting tool retaining features on the die assembly plate. That is, the same die assembly plate and individual cutting tools may be assembled into a number of different die assemblies for providing different patterns of retention features on backing plates.

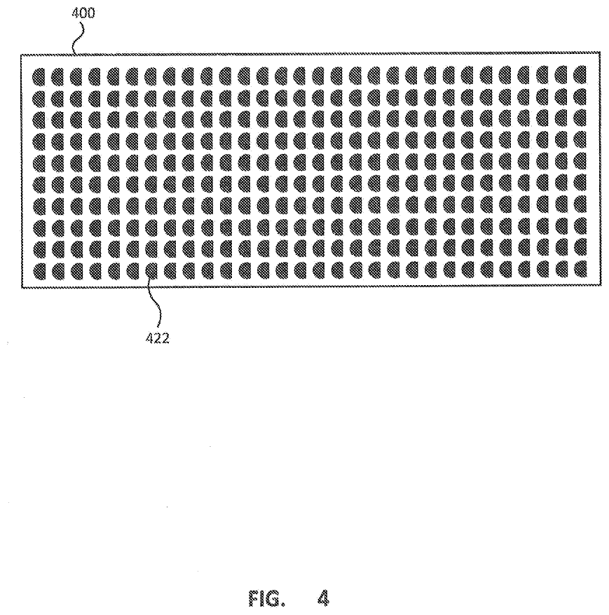

FIG. 4 depicts a die assembly plate 400. The die assembly plate 400 may be used as the die assembly plate 320 depicted in FIGS. 3B and 3C. The die assembly plate 400 provides one or more surfaces or structures (not shown) that allow the die assembly plate 400 to be mounted to the press. The die assembly plate 400 may be retained in the press in various ways including for example using a friction fit, secured in a vise of the press, bolted to the press, etc. Regardless of how the die assembly plate 400 is mounted to the press, it will have a face with a number of cutting tool retaining features, one of which is labelled 422. The individual cutting tool retaining features 422 may take various forms, including threaded holes, protrusions, holes or recesses. The individual cutting tool retaining features 422 allow an individual cutting tool 324 to be secured to the die assembly at a particular location. The cutting tool retaining features 422 are depicted as being arranged in a repeating grid. While a grid of individual cutting tool retaining features 422 provides a wide range of locations that individual cutting tools 324 can be secured, other arrangements of the cutting tool retaining features are possible.

The cutting tool retaining features 422 are depicted as being a D-shaped recess or hole formed within the die assembly plate 400. Advantageously, the D-shaped recess provides a straight face that can be used to easily align a cutting edge of the individual cutting tools 324 since the cutting tool can only be inserted in a single orientation. Further, the D-shaped recess also prevents the cutting tool from rotating within the recess. While there are advantages to the D-shaped recess, other shapes or configurations of the recess, or possibly protrusions are possible including for example, circular, square, rectangular, triangular, or other geometric cross sections.

The assembly plate 400 may comprise more cutting tool retaining features 422 than the number of individual cutting tools 324 used for individual patterns of retention features. For example, the assembly plate 400 is depicted as having a 10×30 grid of D-shaped recesses; while the desired pattern of retention features 304 depicted in FIG. 3A may be formed using 76 individual cutting tools 324. Having more cutting tool retaining features 422 than generally used for a particular pattern of retention features 304 may advantageously allow multiple different patterns of retention features to be formed using the same assembly plate 400 and cutting tools 324; however it is possible for all of the cutting tool retaining features to be used by respective individual cutting tools, which may still be advantageous since damaged cutting edges can be individually replaced simply by replacing the individual cutting tool.

The assembly plate 400 is described as having recesses as the cutting tool retaining features 422. While the assembly plate 400 may be used with only a subset of the recesses occupied by individual cutting tools 324, the assembly plate 400 may be further strengthened by inserting blanks into the recesses that are not occupied by cutting tools.

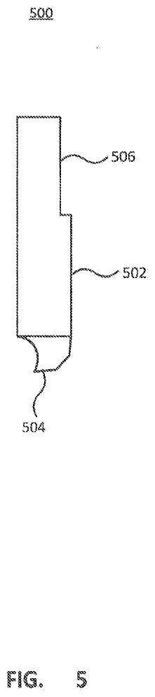

FIG. 5 depicts an individual cutting tool 500. The cutting tool 500 may be formed in various ways. The cutting tool 500 comprises a shank 502 which may have a circular, square or rectangular cross section. A cutting edge 504 is formed at one end of the shank. The particular dimensions and geometries of the cutting edge 504 may vary depending upon various factors including for example a desired shape of the resulting retention feature formed by the cutting tool 500, a material used to form the cutting tool, an expected material of the backing plates, and/or a desired or expected lifetime of the cutting tool. At an end of the shank 502 opposite the cutting edge 504 a retaining feature 506 is formed that corresponds to the cutting tool retaining feature 322, 422 of the die assembly plate 320, 400. In the case of assembly plate 400 described above which used a D-shaped recess, the retaining feature 506 formed on the cutting tool would be a D-shaped projection, protrusion or section that is sized to fit within the D-shaped recess. It will be appreciated that the retaining feature 506 of the individual cutting tools corresponds to the cutting tool retaining features 322, 422 formed in the die assembly plate 320, 400.

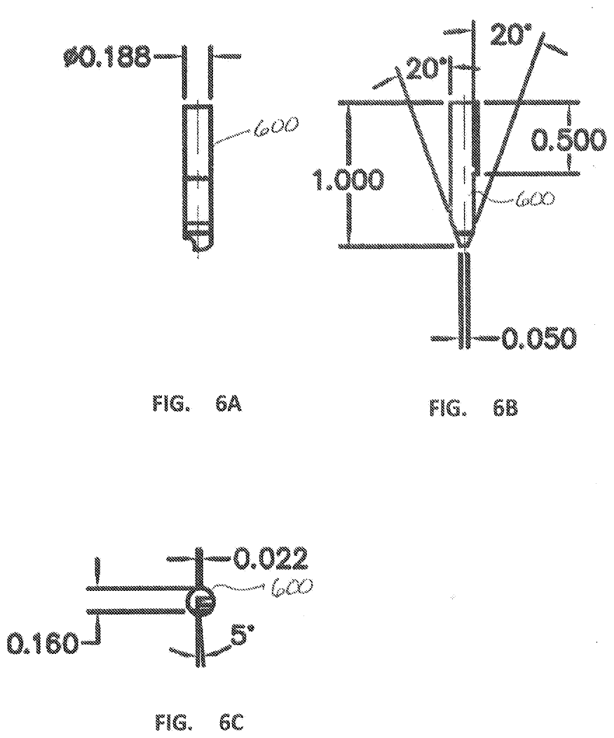

FIG. 6A depicts a side view of an individual cutting tool 600, which in embodiments may take the form of cutting tool 324 of FIG. 3B or cutting tool 500 of FIG. 5. FIG. 6B depicts a front view of the individual cutting tool 600 of FIG. 6A. FIG. 6C depicts a bottom view of the individual cutting tool 600 of FIG. 6A. The individual cutting tool 600 is depicted in FIGS. 6A-6C with illustrative dimensions. The individual cutting tools 600 may be formed from tool steel or alloys. The cutting edge, such as cutting edge 504, may be provided by a separate material, such as carbide or diamond, that has been attached to the cutting tool 500. In contrast to the cutting tool 500, the cutting tool 600 has a reduced size shank compared to the size of the collar or retaining feature, which for use with a die assembly plate 320, 400 as described above with reference to FIG. 4 may be a D-shaped collar section.

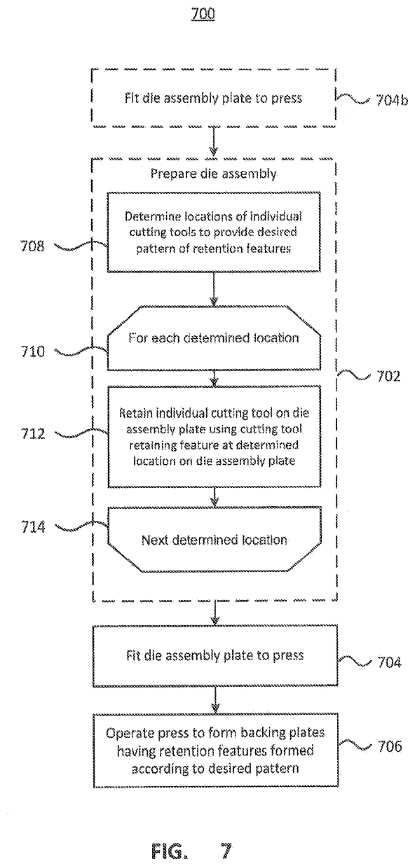

FIG. 7 is an exemplary embodiment of a method of forming backing plates 102 using a die assembly 702. The method 700 comprises preparing the die assembly 702 with the individual cutting tools and then fitting the die assembly, or more particularly the die assembly plate 320, 400, in a press 704. Although depicted as being performed after preparing the die assembly, it is possible to fit the die assembly, or more particularly the die assembly plate 324, 400, to the press 702 prior to preparing the die assembly with the individual cutting tools. For example, if the die assembly plate 320, 400 is already installed in the press, one or more of the individual cutting tools 324, 500 may be secured to the die assembly plate 320, 400 without removing it from the press. This may be particularly useful when replacing one or more damaged cutting edges, or when making minor changes to the desired pattern of retention features formed by the die assembly 702. Once the die assembly 702 with the individual cutting tools 324, 500 to provide the desired pattern of retention features in a backing plate is fitted to the press, the press may be operated to form the desired pattern of retention features on backing plates.

As depicted in FIG. 7, preparing the die assembly 702 comprises determining locations of individual cutting tools to provide a desired pattern of retention features 708. The locations of individual cutting tools may be determined in various ways, such as using an overlay of the desired pattern, using a listing specifying individual locations for a particular pattern, or using a visual guide, such as a projected light to identify the locations, or comparing the locations of cutting tool retaining features to a known pattern or template. For each of the locations 710 an individual cutting tool is retained on the die assembly plate using the cutting tool retaining feature at the respective location. Once the individual cutting tool is secured to the assembly plate at the appropriate location, the next determined location 714 is used to secure another individual cutting tool to the die assembly plate 320, 400. Once individual cutting tools are secured to the die assembly plate at each of the determined locations, the resulting die assembly may be used in the press to form backing plates for friction assemblies.

If a damaged cutting edge or cutting tool is detected, for example by examining the pattern of retention features 304 formed on a backing plate 202, the cutting tool can be removed from the die assembly plate 320, 400, either with the die assembly plate in the press or after the die assembly plate has been removed from the press, and replaced with an undamaged cutting tool.

Although specific embodiments are described herein, it will be appreciated that modifications may be made to the embodiments without departing from the scope of the current teachings. Accordingly, the scope of the appended claims should not be limited by the specific embodiments set forth but should be given the broadest interpretation consistent with the teachings of the description as a whole.

What is claimed is:

1. A method of preparing a press to form a backing plate for a friction assembly, the method comprising:
determining a plurality of individual cutting tool locations in a die assembly plate to provide a desired pattern of retention features on a backing plate for retaining a friction material the die assembly plate comprising a plurality of individual cutting tool retention features, each of the plurality of individual cutting tool retention features capable of retaining a respective individual cutting tool;
for each individual cutting tool location of the determined plurality of individual cutting tool locations in the die assembly plate, retaining a respective individual cutting tool by a respective cutting tool retention feature of the die assembly plate at the individual cutting tool location; and
fitting the die assembly plate to the press.

2. The method of claim 1, wherein each individual cutting tool comprises a pin having a single cutting edge.

3. The method of claim 2, wherein the pin of a respective individual cutting tool has a cross-sectional profile to align an orientation of the cutting edge relative to the die assembly plate when the respective individual cutting tool is retained by the cutting tool retention feature.

4. The method of claim 3, wherein the cross-sectional profile to the respective individual cutting tool is a D shape.

5. The method of claim 1, wherein each individual cutting tool retention feature comprises a hole or recess within the die assembly plate shaped to receive the respective individual cutting tool, and wherein retaining each individual cutting tool in the respective cutting tool comprises inserting the individual cutting tool in the hole or recess within the die assembly plate.

6. The method of claim 1, wherein fitting the die assembly plate to the press is done after retaining one or more of each individual cutting tool in the die assembly plate.

7. The method of claim 1, wherein fitting the die assembly plate to the press is done prior to retaining one or more of each individual cutting tool in the die assembly plate.

8. A method of forming backing plates for a friction assembly, the method comprising:
preparing a press according to claim 1; and
operating the press to form a plurality of backing plates having retention features formed in accordance with the desired retention feature pattern.

9. The method of claim 8, further comprising:
determining that an individual cutting tool should be replaced; and
replacing the determined individual cutting tool.

10. A die assembly comprising:
a die assembly plate having at least one mounting surface for use in retaining the die assembly plate within a press for manufacturing backing plates of friction assemblies, wherein the die assembly comprises a first plurality of retention features arranged over a face of the die assembly plate, each of the retention features shaped to retain an individual cutting tool; and
a second plurality, less than the first plurality, of individual cutting tools retained by respective retention features of the die assembly plate.

11. The die assembly of claim 10, wherein each individual cutting tool comprises a pin having a single cutting edge.

12. The die assembly of claim 11, wherein the pin of a respective individual cutting tool has a cross-sectional profile to align an orientation of the cutting edge relative to the die assembly plate when the respective individual cutting tool is retained by the cutting tool retention feature.

13. The die assembly of claim 12, wherein the cross-sectional profile to the respective individual cutting tool is a D shape.

14. The die assembly of claim 10, wherein each individual cutting tool retention feature comprises a hole or recess within the die assembly plate shaped to receive the respective individual cutting tool, and wherein each individual cutting tool is retained in the respective cutting tool by a friction fit of the individual cutting tool in the hole or recess within the die assembly plate.
